(19) United States
(12) Patent Application Publication
(10) Pub. No.: US 2026/0245823 A1
(43) Pub. Date: Aug. 20, 2026

(54) THERMAL FUSE WITH IMPROVED SEALING

(71) Applicant: ELECTRICAL COMPONENTS INTERNATIONAL, INC., St. Louis, MO (US)

(72) Inventors: Gary Schultz, Kitchener (CA); Duncan Whitelaw, Ingersoll (CA); Paul Csanyi, Tilsonburg (CA)

(21) Appl. No.: 19/340,200

(22) Filed: Sep. 25, 2025

Related U.S. Application Data
(60) Provisional application No. 63/700,923, filed on Sep. 30, 2024.

(51) Int. Cl. H01H 85/143; H01H 69/02; H01H 85/055; H01R 4/20

(52) U.S. Cl. CPC H01H 85/143; H01H 69/02; H01H 85/055; H01R 4/20

(57) ABSTRACT

A system includes a component lead wire which is crimped to a first lead wire from a thermal fuse at a first crimp. The thermal fuse has a second lead wire which is crimped to a power lead wire to communicate to a source of power at a second crimp. Protective material is positioned outwardly of the thermal fuse. The protective material is heat staked to one of the component and first lead lines at a location spaced from the thermal fuse and also is heat staked to one of the power and second lead lines at a location spaced from the thermal fuse. A method is also disclosed.

### CROSS-REFERENCE TO RELATED APPLICATIONS

This application claims priority to U.S. Provisional Application No. 63/700,923 filed Sep. 30, 2024.

### BACKGROUND

This application relates to a thermal fuse that is sealed with heat applied spaced from the thermal fuse.

Thermal fuses are known, and utilized in any number of modern applications. As one example, a thermal fuse may be utilized in an appliance. The thermal fuse is positioned between an appliance, and a source of power. A wire from the thermal fuse is spliced to a wire heading to the appliance, and to a wire from the power source.

A thermal fuse is a safety device which will open when a set temperature is exceeded for set period of time. Typically a thermal fuse must be replaced when it is opened.

It is known in the art to provide sealing of the thermal fuse with tubing. A glue requires heat to be applied to shrink the tube. In the prior art the heat has been applied to the thermal fuse itself.

The heat may exceed the trip temperature for the thermal fuse, but usually not for the period of time required to trip the fuse. This may leave the fuse in partially tripped state. This could impact the behavior of the thermal fuse to substantially deviate from a specified behavior.

### SUMMARY

A system includes a component lead wire which is crimped to a first lead wire from a thermal fuse at a first crimp. The thermal fuse has a second lead wire which is crimped to a power lead wire to communicate to a source of power at a second crimp. Protective material is positioned outwardly of the thermal fuse. The protective material is heat staked to one of the component and first lead lines at a location spaced from the thermal fuse and also is heat staked to one of the power and second lead lines at a location spaced from the thermal fuse.

These and other features will be best understood from the following drawings and specification, the following is a brief description.

### BRIEF DESCRIPTION OF THE DRAWINGS

FIG. 1 schematically shows a power supply to a component.

FIG. 2 shows a thermal fuse sealing method according to this disclosure.

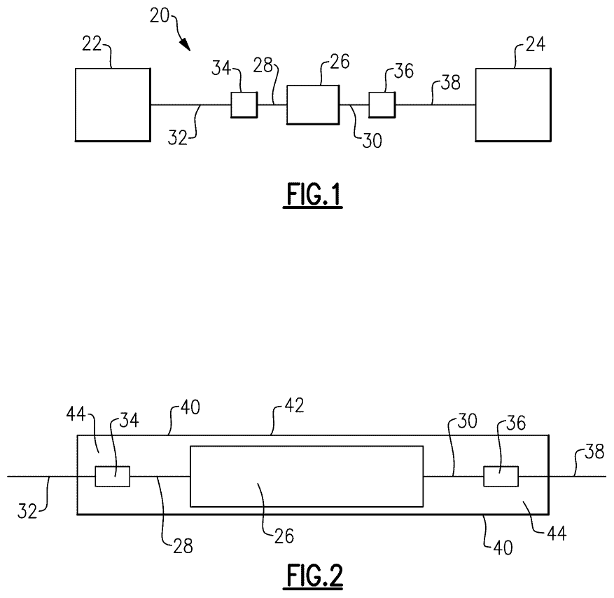

### DETAILED DESCRIPTION

A thermal fuse 26 is employed in a system 20. The system 20 includes a component 22 to receive power. Example components may be an appliance that is heat producing, such as, hair dryers, clothes dryers, etc. A power source 24 communicates to the component 22 through a thermal fuse 26. Electric lead line 28 from the thermal fuse 26 is crimped at 34 to the electrical line 32 leading to the component 22. Similarly, a lead 30 into the thermal fuse 26 is crimped at 36 to a line 38 from the power source 24. Line 38 may include an electrical plug.

FIG. 2 shows a detail of the thermal fuse 26 and splices 34 and 36. Outer tubing 40 and 42 extends beyond the splices 34 and 36, and enclose the fuse 26.

However, contrary to the prior art mentioned above, there is now heat staking at ends 44 which are on opposed sides of the splices 34 and 36 relative to the thermal fuse 42.

Now heat is not applied to the portion 42 of the tubing surrounding the thermal fuse 26.

The problem mentioned above with regard to applying heat to the thermal fuse is avoided.

The tubing 40/42 may be clear polyvinyl chloride (“PVC”) tubing.

In a featured embodiment, a system includes a component lead wire which is crimped to a first lead wire from a thermal fuse at a first crimp. The thermal fuse has a second lead wire which is crimped to a power lead wire to communicate to a source of power at a second crimp. Protective material is positioned outwardly of the thermal fuse. The protective material is heat staked to one of the component and first lead lines at a location spaced from the thermal fuse and also is heat staked to one of the power and second lead lines at a location spaced from the thermal fuse.

In another embodiment according to the previous embodiment, the protective material is tubing.

In another embodiment according to any of the previous embodiments, the heat staking is provided on opposed sides of the first and second crimps relative to the thermal fuse.

In another embodiment according to any of the previous embodiments, the protective tubing is a clear plastic tubing.

In another embodiment according to any of the previous embodiments, the protective tubing is polyvinyl chloride.

In another embodiment according to any of the previous embodiments, the first and second crimps are brass crimps.

In another embodiment according to any of the previous embodiments, the thermal fuse is configured to provide an open circuit between the power source and the component should a set temperature be reached at the thermal fuse for at least a set period of time.

In another embodiment according to any of the previous embodiments, the heat staking is provided on opposed sides of the first and second crimps relative to the thermal fuse.

In another featured embodiment, a system includes a component. A system includes a component lead wire which is crimped to a first lead wire from a thermal fuse at a first crimp. The thermal fuse has a second lead wire which is crimped to a power lead wire communicating with a source of power at a second crimp. Protective material is positioned outwardly of the thermal fuse. The protective material is heat staked to one of the component and first lead lines at a location spaced from the thermal fuse and also being heat staked to one of the power and second lead lines at a location spaced from the thermal fuse.

In another embodiment according to any of the previous embodiments, the protective material is tubing.

In another embodiment according to any of the previous embodiments, the heat staking is provided on opposed sides of the first and second crimps relative to the thermal fuse.

In another embodiment according to any of the previous embodiments, the protective tubing is a clear plastic tubing.

In another embodiment according to any of the previous embodiments, the protective tubing is polyvinyl chloride.

In another embodiment according to any of the previous embodiments, the first and second crimps are brass crimps.

In another embodiment according to any of the previous embodiments, the component is a heat producing appliance.

In another embodiment according to any of the previous embodiments, the heat-producing appliance is one of a hair dryer or a clothes dryer.

In another embodiment according to any of the previous embodiments, the heat staking is provided on opposed sides of the first and second crimps relative to the thermal fuse.

In another featured embodiment, a method of forming an electrical connection to connect a power source to a component includes the steps of crimping a first lead wire from a thermal fuse at a first crimp to a component lead wire to be connected to a component, crimping a second lead wire from the thermal fuse to a power lead line to be connected with a source of power at a second crimp and positioning a protective material outwardly of the thermal fuse, and heat staking the protective material to one of the component and first lead lines at a location spaced from the thermal fuse and also heat staking one of the power and second lead lines at a location spaced from the heat fuse.

In another embodiment according to any of the previous embodiments, the heat staking is provided on opposed sides of the first and second crimps relative to the thermal fuse.

Although an embodiment has been disclosed, a worker of skill in this art would recognize that modifications would come within the scope of this disclosure. For that reason the following claims should be studied to determine the true scope and content of this disclosure.

What is claimed is:

1. A system comprising:
a component lead wire which is crimped to a first lead wire from a thermal fuse at a first crimp, the thermal fuse having a second lead wire which is crimped to a power lead wire to communicate to a source of power at a second crimp;
protective material positioned outwardly of the thermal fuse, the protective material being heat staked to one of the component and first lead lines at a location spaced from the thermal fuse and also being heat staked to one of the power and second lead lines at a location spaced from the thermal fuse.

2. The system as set forth in claim 1, wherein the protective material is tubing.

3. The system as set forth in claim 2, wherein the heat staking is provided on opposed sides of the first and second crimps relative to the thermal fuse.

4. The system as set forth in claim 3, wherein the protective tubing is a clear plastic tubing.

5. The system as set forth in claim 3, wherein the protective tubing is polyvinyl chloride.

6. The system as set forth in claim 2, wherein the first and second crimps are brass crimps.

7. The system as set forth in claim 1, wherein the thermal fuse is configured to provide an open circuit between the power source and the component should a set temperature be reached at the thermal fuse for at least a set period of time.

8. The system as set forth in claim 1, wherein the heat staking is provided on opposed sides of the first and second crimps relative to the thermal fuse.

9. A system comprising:
a component;
a system including a component lead wire which is crimped to a first lead wire from a thermal fuse at a first crimp, the thermal fuse having a second lead wire which is crimped to a power lead wire communicating with a source of power at a second crimp;
protective material positioned outwardly of the thermal fuse, the protective material being heat staked to one of the component and first lead lines at a location spaced from the thermal fuse and also being heat staked to one of the power and second lead lines at a location spaced from the thermal fuse.

10. The system as set forth in claim 9, wherein the protective material is tubing.

11. The system as set forth in claim 10, wherein the heat staking is provided on opposed sides of the first and second crimps relative to the thermal fuse.

12. The system as set forth in claim 11, wherein the protective tubing is a clear plastic tubing.

13. The system as set forth in claim 12, wherein the protective tubing is polyvinyl chloride.

14. The system as set forth in claim 11, wherein the first and second crimps are brass crimps.

15. The system as set forth in claim 9, wherein the component is a heat producing appliance.

16. The system as set forth in claim 15, wherein the heat-producing appliance is one of a hair dryer or a clothes dryer.

17. The system as set forth in claim 9, wherein the heat staking is provided on opposed sides of the first and second crimps relative to the thermal fuse.

18. A method of forming an electrical connection to connect a power source to a component comprising the steps of:
crimping a first lead wire from a thermal fuse at a first crimp to a component lead wire to be connected to a component;
crimping a second lead wire from the thermal fuse to a power lead line to be connected with a source of power at a second crimp;
positioning a protective material outwardly of the thermal fuse, and heat staking the protective material to one of the component and first lead lines at a location spaced from the thermal fuse and also heat staking one of the power and second lead lines at a location spaced from the heat fuse.

19. The method as set forth in claim 18, wherein the heat staking is provided on opposed sides of the first and second crimps relative to the thermal fuse.
